(19) United States
(12) Patent Application Publication
(10) Pub. No.: US 2024/0041210 A1
(43) Pub. Date: Feb. 8, 2024

(54) Heated Camping Chair Assembly

(71) Applicant: Mark Dukart, Selah, WA (US)

(72) Inventor: Mark Dukart, Selah, WA (US)

(21) Appl. No.: 17/881,113

(22) Filed: Aug. 4, 2022

(51) Int. Cl. A47C 1/14; H05B 3/34; H05B 1/02; A47C 7/74; A47C 4/28

(52) U.S. Cl. CPC A47C 1/14; H05B 3/342; H05B 1/0272; A47C 7/748; A47C 4/28

(57) ABSTRACT

A heated camping chair assembly includes a camping chair that has a membrane that defines a pouch which facilitates a user to sit in the pouch and a pair of pockets is each integrated into the membrane. A blanket is provided and a heating coil is integrated into the blanket to heat the blanket when the heating coil is turned on. A control unit is positionable in a respective one of the pockets in the membrane of the camping chair. The heating coil is pluggable into the control unit and a battery well is integrated into the control unit. A rechargeable battery is insertable into the battery well in the control unit to power the heating coil in the blanket. A remote control is provided to facilitate the user to remotely control the heating coil in the blanket when the heating coil is plugged into the control unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to heated chair devices and more particularly pertains to a new heated chair device for keeping a user warm while the user is seated. The device includes a camping chair and a blanket that has an electric heating coil. A control unit is provided and a rechargeable battery is provided which is positionable in the control unit. The electric heating coil is pluggable into the control unit for powering the electric heating coil. In this way the blanket can keep the user warm while the user is seated in the camping chair. A remote control is provided for remotely controlling the control unit.

### (2) Description of Related Art Including Information Disclosed Under 37 CFR 1.97 and 1.98

The prior art relates to heated chair devices including a foldable lawn chair that has a heating element integrated therein. The prior art discloses a variety of camping chairs that each has a heating element integrated into the camping chair. The prior art discloses a heated chair device that includes a heating unit that is positionable in a variety of locations on a chair for heating the chair.

### BRIEF SUMMARY OF THE INVENTION

An embodiment of the disclosure meets the needs presented above by generally comprising a camping chair that has a membrane that defines a pouch which facilitates a user to sit in the pouch and a pair of pockets is each integrated into the membrane. A blanket is provided and a heating coil is integrated into the blanket to heat the blanket when the heating coil is turned on. A control unit is positionable in a respective one of the pockets in the membrane of the camping chair. The heating coil is pluggable into the control unit and a battery well is integrated into the control unit. A rechargeable battery is insertable into the battery well in the control unit to power the heating coil in the blanket. A remote control is provided to facilitate the user to remotely control the heating coil in the blanket when the heating coil is plugged into the control unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a heated camping chair assembly according to an embodiment of the disclosure.

FIG. 2 is a perspective view of an embodiment of the disclosure.

FIG. 3 is a front phantom view of an embodiment of the disclosure.

FIG. 4 is a perspective view of control unit and a rechargeable battery of an embodiment of the disclosure.

FIG. 5 is a cut-away view of control unit and a remote control of an embodiment of the disclosure.

FIG. 6 is a perspective in-use view of an embodiment of the disclosure.

### DETAILED DESCRIPTION OF THE INVENTION

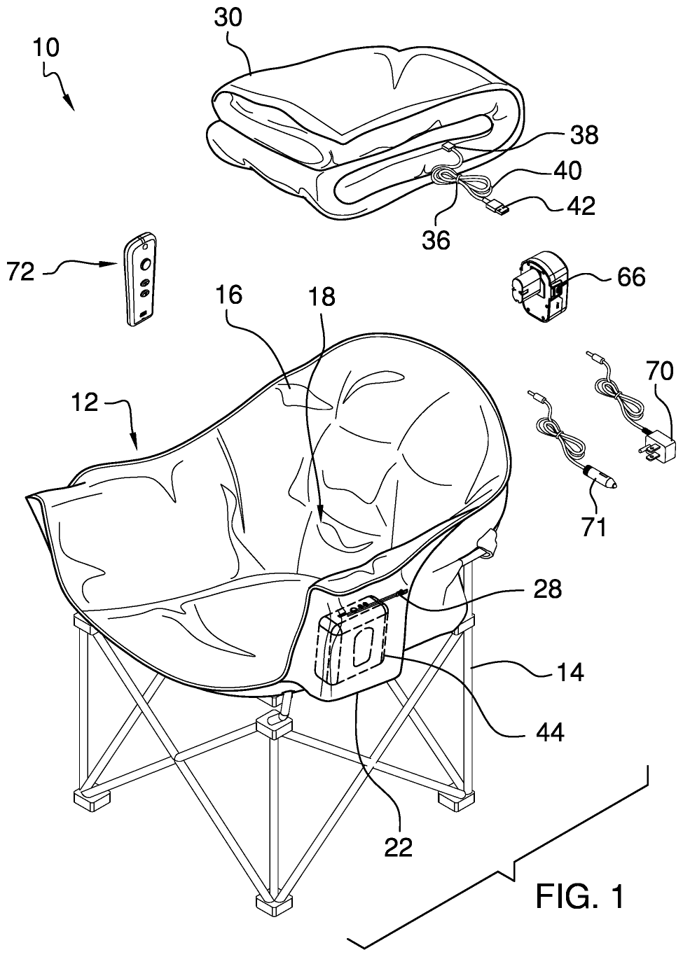

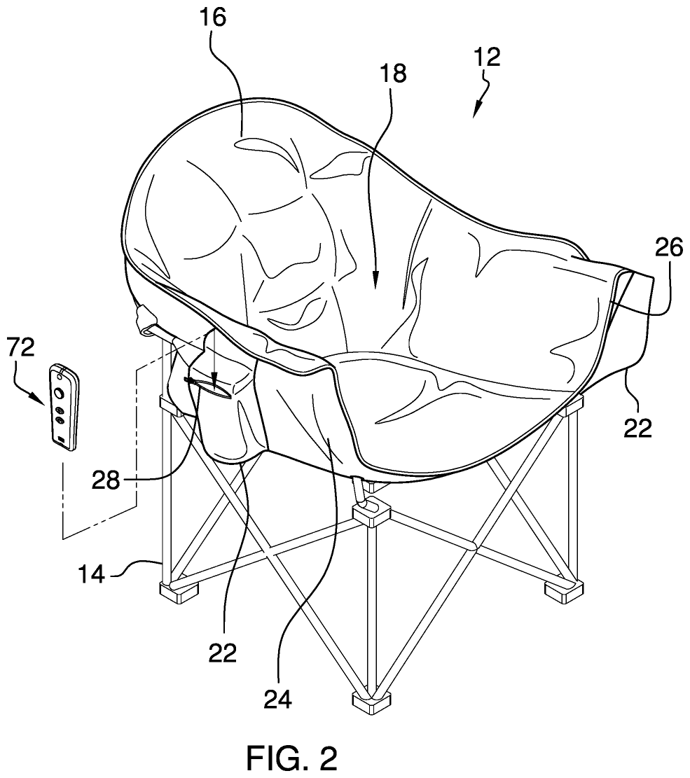

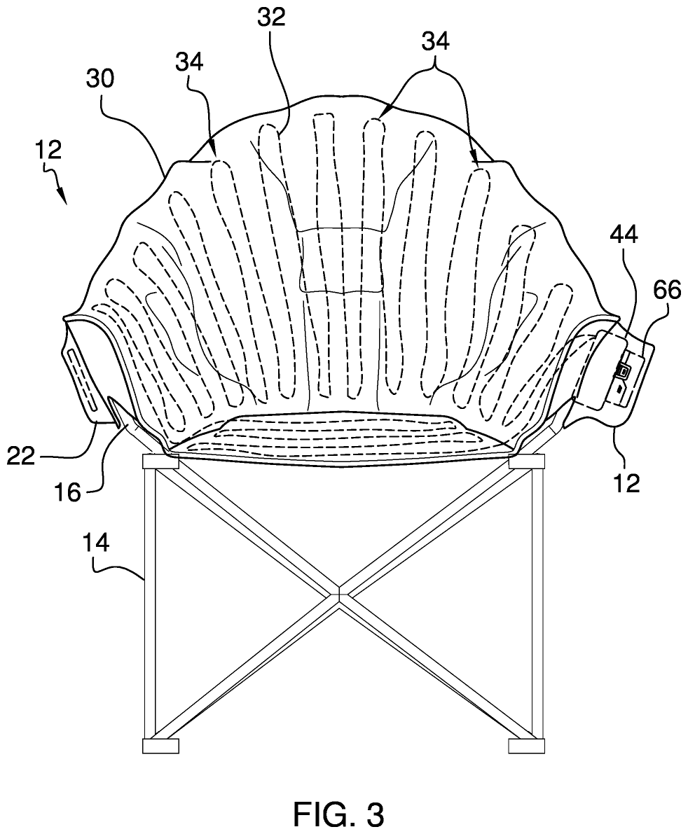

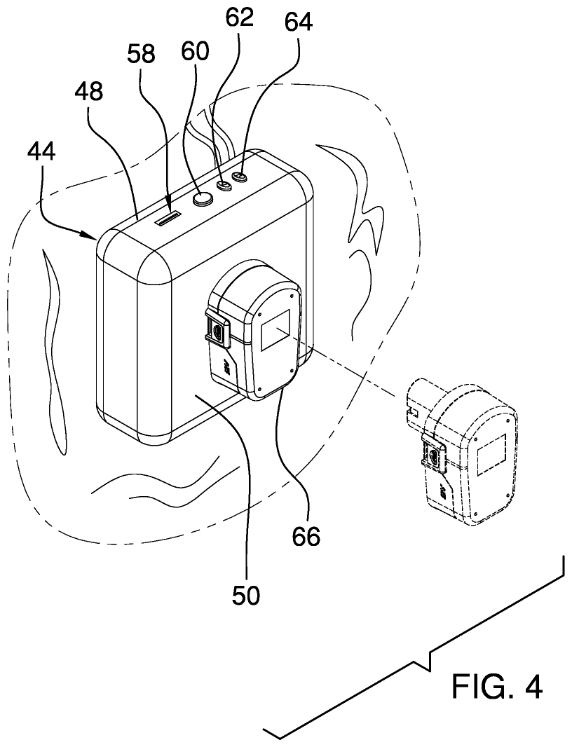

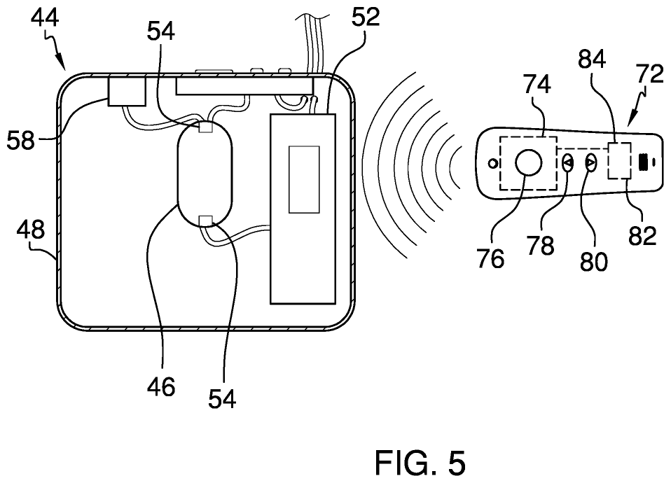

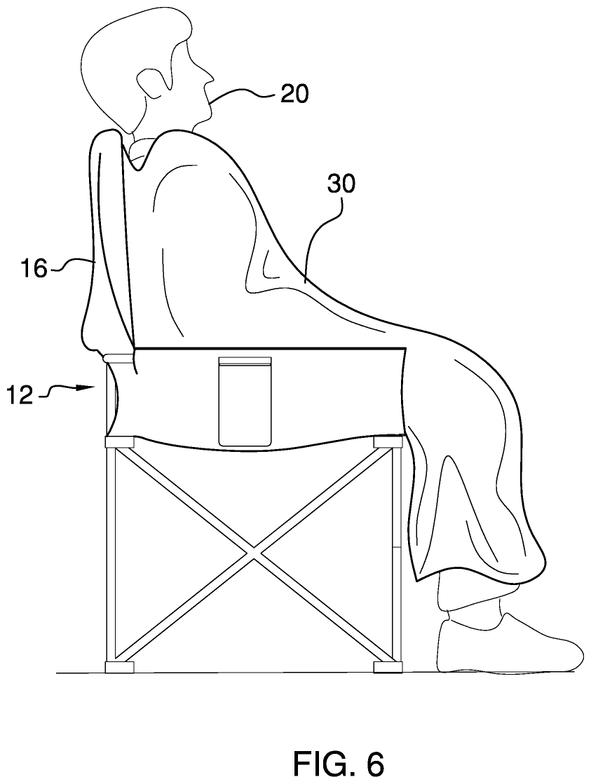

With reference now to the drawings, and in particular to FIGS. 1 through 6 thereof, a new heated chair device embodying the principles and concepts of an embodiment of the disclosure and generally designated by the reference numeral 10 will be described.

As best illustrated in FIGS. 1 through 6, the heated camping chair assembly 10 generally comprises a camping chair 12 that has a collapsible frame 14 and a membrane 16 that is positioned around the collapsible frame 14. The membrane 16 defines a pouch 18 which facilitates a user 20 to sit in the pouch 18 when the collapsible frame 14 is unfolded. The membrane 16 may be comprised of canvas, vinyl or other resilient and deformable textile. The camping chair 12 has a pair of pockets 22 that is each integrated into the membrane 16. Each of the pockets 22 is positioned on a respective first lateral side 24 and second lateral side 26 of the membrane 16 that are defined when the collapsible frame 14 is positioned in a deployed position. A pair of closures 28 is each integrated into the membrane 16 and each of the closures 28 is aligned with a respective one of the pockets 22. Each of the closures 28 is positionable in a closed position for closing the respective pocket 22 and each of the closures 28 is positionable in an open position for opening the respective pocket 22. Each of the closures 28 may comprise a zipper or other type of mechanical closure.

A blanket 30 is positionable over the user 20 when the user 20 in the camping chair 12. The blanket 30 is comprised of a thermally insulating material to inhibit thermal transfer between the user 20 and ambient air to warm the user 20. A heating coil 32 is integrated into the blanket 30 and the heating coil 32 is in thermal communication with the blanket 30 such that the heating coil 32 heats the blanket 30 when the heating coil 32 is turned on. The heating coil 32 is formed into a plurality of loops 34 that are distributed over a substantial area of the blanket 30. A power cord 36 is coupled to and extends away from the blanket 30 and the power cord 36 is in communication with the heating coil 32. The power cord 36 has a coupled end 38 and a free end 40, the coupled end 38 is electrically coupled to the heating coil 32 and the power cord 36 has a power plug 42 that is electrically coupled to the free end 40. The heating coil 32 may comprise an electric heating coil or the like with an operational temperature of less than 120.0 degrees Fahrenheit.

A control unit 44 is provided and the control unit 44 is positionable in a respective one of the pockets 22 in the membrane 16 of the camping chair 12. The power cord 36 is pluggable into the control unit 44 thereby facilitating the control unit 44 to control the heating coil 32. The control unit 44 has a battery well 46 that is integrated into the control unit 44. The control unit 44 comprises a housing 48 that has a first wall 50 and the battery well 46 associated with the control unit 44 is recessed into the first wall 50. The control unit 44 includes a control circuit 52 that is integrated into the housing 48 and the control circuit 52 is electrically coupled to charging contacts 54 in the battery well 46.

The control unit 44 includes a receiver 56 that is integrated into the housing 48 and the receiver 56 is electrically coupled to the control circuit 52. An output port 58 is recessed into the housing 48 and the output port 58 is electrically coupled to the control circuit 52. Additionally, the output port 58 insertably receives the power plug 42 on the free end 40 of the power cord 36 such that the control circuit 52 is in electrical communication with the heating coil 32. A power button 60 is movably integrated into the housing 48 and the power button 60 is electrically coupled to the control circuit 52 for turning the control circuit 52 on and off. A temperature increase button 62 is movably integrated into the housing 48, the temperature increase button 62 is electrically coupled to the control circuit 52 and a temperature of the heating coil 32 is increased toward a maximum temperature when the temperature increase button 62 is depressed. A temperature decrease button 64 is movably integrated into the housing 48, the temperature decrease button 64 is electrically coupled to the control circuit 52 and a temperature of the heating coil 32 is decreased toward a minimum temperature when the temperature decrease button 64 is depressed.

A rechargeable battery 66 is provided and the rechargeable battery 66 is insertable into the battery well 46 in the control unit 44 such that the rechargeable battery 66 is in electrical communication with the heating coil 32 in the blanket 30 when the power cord 36 is plugged into the control unit 44. The rechargeable battery 66 has a charging plug 68 extending away from the rechargeable battery 66. Furthermore, the charging plug 68 extends into the battery well 46 in first wall 50 of the housing 48 of the control unit 44 such that the charging plug 68 electrically engages the charging contacts in the battery well 46. The rechargeable battery 66 may comprise an 18.0 volt lithium ion battery for a cordless drill, for example, or other type of cordless tool that would commonly be found in a residence. A charger 70 is provided and the rechargeable battery 66 is can be connected to the charger 70 for charging the rechargeable battery 66. The charger 70 may comprise a battery charger for the cordless drill, for example, or other cordless tool. As is most clearly shown in FIG. 1, the charger 70 may include a cigarette lighter adapter 71 for charging the rechargeable battery 66 in a cigarette lighter of a vehicle.

A remote control 72 is provided and the remote control 72 is in remote communication with the control unit 44. In this way the user 20 can remotely control the heating coil 32 in the blanket 30 when the power cord 36 is plugged into the control unit 44. The remote control 72 comprises a transmitter 74 that is in wireless communication with the receiver 56 associated with the control unit 44. The transmitter 74 may comprise a radio frequency transmitter or the like.

An actuate button 76 is movably integrated into the remote control 72, the actuate button 76 is electrically coupled to the transmitter 74 and the control circuit 52 associated with the control unit 44 is turned on when the actuate button 76 is manipulated. An increase button 78 is movably integrated into the remote control 72, the increase button 78 is electrically coupled to the transmitter 74 and the heating coil 32 is increased toward a maximum temperature when the increase button 78 is depressed. A decrease button 80 is movably integrated into the remote control 72, the decrease button 80 is electrically coupled to the transmitter 74 and the heating coil 32 is decreased toward a maximum temperature when the decrease button 80 is depressed. A remote power supply 82 is positioned in the remote control 72, the remote power supply 82 is electrically coupled to the transmitter 74 and the remote power supply 82 comprises at least one battery 84.

In use, the rechargeable battery 66 is plugged into the battery well 46 in the control unit 44 and the power cord 36 is plugged into the output port 58 in the control unit 44. The control unit 44 is manipulated to turn on the heating coil 32 in the blanket thereby warming the blanket 30. In this way the user 20 can stay warm while the user is sitting in the chair 12 on a cool evening, for example, or other occasion that might involve temperatures the user 20 would find to be uncomfortably cold. The rechargeable battery 66 can be placed in the battery charger 70 at any time the charge the rechargeable battery 66. Additionally, the user 20 can employ the remote control 72 to adjust the temperature of the heating coil 32 or the turn the heating coil 32 on and off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated camping chair assembly for keeping a user warm while the user is sitting outdoors, said assembly comprising:
a camping chair having a collapsible frame and a membrane being positioned around said collapsible frame such that said membrane defines a pouch which facilitates a user to sit in said pouch, said camping chair having a pair of pockets each being integrated into said membrane;
a blanket being positionable over the user when the user in said camping chair, said blanket being comprised of a thermally insulating material to inhibit thermal transfer between the user and ambient air wherein said blanket is configured to warm the user;
a heating coil being integrated into said blanket, said heating coil being in thermal communication with said blanket such that said heating coil heats said blanket when said heating coil is turned on;
a power cord being coupled to and extending away from said blanket, said power cord being in communication with said heating coil;
a control unit being positionable in a respective one of said pockets in said membrane of said camping chair, said power cord being pluggable into said control unit thereby facilitating said control unit to control said heating coil, said control unit having a battery well being integrated into said control unit;
a rechargeable battery being insertable into said battery well in said control unit such that said rechargeable battery is in electrical communication with said heating coil in said blanket when said power cord is plugged into said control unit; and
a remote control being in remote communication with said control unit thereby facilitating the user to remotely control said heating coil in said blanket when said power cord is plugged into said control unit.

2. The assembly according to claim 1, wherein:
each of said pockets is positioned on a respective first lateral side and second lateral side of said membrane that are defined when said collapsible frame is positioned in a deployed position; and
said assembly includes a pair of closures, each of said closures being integrated into said membrane, each of said closures being aligned with a respective one of said pockets, each of said closures being positionable in a closed position for closing said respective pocket, each of said closures being positionable in an open position for opening said respective pocket.

3. The assembly according to claim 1, wherein:
said power cord has a coupled end and a free end, said coupled end being electrically coupled to said heating coil, said power cord having a power plug being electrically coupled to said free end; and
said control unit comprises:
a housing having a first wall, said battery well associated with said control unit being recessed into said first wall;
a control circuit being integrated into said housing, said control circuit being electrically coupled to charging contacts in said battery well; and
an output port being recessed into said housing, said output port being electrically coupled to said control circuit, said output port insertably receiving said power plug on said free end of said power cord such that said control circuit is in electrical communication with said heating coil.

4. The assembly according to claim 3, wherein said control unit includes:
a receiver being integrated into said housing, said receiver being electrically coupled to said control circuit;
a power button being movably integrated into said housing, said power button being electrically coupled to said control circuit for turning said control circuit on and off;
a temperature increase button being movably integrated into said housing, said temperature increase button being electrically coupled to said control circuit, a temperature of said heating coil being increased toward a maximum temperature when said temperature increase button is depressed; and
a temperature decrease button being movably integrated into said housing, said temperature decrease button being electrically coupled to said control circuit, a temperature of said heating coil being decreased toward a minimum temperature when said temperature decrease button is depressed.

5. The assembly according to claim 3, wherein said rechargeable battery has a charging plug extending away from said rechargeable battery, said charging plug extending into said battery well in first wall of said housing of said control unit such that said charging plug electrically engages said charging contacts in said battery well.

6. The assembly according to claim 4, wherein said remote control comprises:
a transmitter being in wireless communication with said receiver associated with said control unit;
an actuate button being movably integrated into said remote control, said actuate button being electrically coupled to said transmitter, said control circuit associated with said control unit being turned on when said actuate button is manipulated;
an increase button being movably integrated into said remote control, said increase button being electrically coupled to said transmitter, said heating coil being increased toward a maximum temperature when said increase button is depressed;
an decrease button being movably integrated into said remote control, said decrease button being electrically coupled to said transmitter, said heating coil being decreased toward a maximum temperature when said decrease button is depressed; and
a remote power supply being positioned in said remote control, said remote power supply being electrically coupled to said transmitter, said remote power supply comprising at least one battery.

7. A heated camping chair assembly for keeping a user warm while the user is sitting outdoors, said assembly comprising:
a camping chair having a collapsible frame and a membrane being positioned around said collapsible frame such that said membrane defines a pouch which facilitates a user to sit in said pouch, said camping chair having a pair of pockets each being integrated into said membrane, each of said pockets being positioned on a respective first lateral side and second lateral side of said membrane that are defined when said collapsible frame is positioned in a deployed position;
a pair of closures, each of said closures being integrated into said membrane, each of said closures being aligned with a respective one of said pockets, each of said closures being positionable in a closed position for closing said respective pocket, each of said closures being positionable in an open position for opening said respective pocket;
a blanket being positionable over the user when the user in said camping chair, said blanket being comprised of a thermally insulating material to inhibit thermal transfer between the user and ambient air wherein said blanket is configured to warm the user;
a heating coil being integrated into said blanket, said heating coil being in thermal communication with said blanket such that said heating coil heats said blanket when said heating coil is turned on, said heating coil being formed into a plurality of loops being distributed over a substantial area of said blanket;
a power cord being coupled to and extending away from said blanket, said power cord being in communication with said heating coil, said power cord having a coupled end and a free end, said coupled end being electrically coupled to said heating coil, said power cord having a power plug being electrically coupled to said free end;
a control unit being positionable in a respective one of said pockets in said membrane of said camping chair, said power cord being pluggable into said control unit thereby facilitating said control unit to control said heating coil, said control unit having a battery well being integrated into said control unit, said control unit comprising:
a housing having a first wall, said battery well associated with said control unit being recessed into said first wall;
a control circuit being integrated into said housing, said control circuit being electrically coupled to charging contacts in said battery well;
a receiver being integrated into said housing, said receiver being electrically coupled to said control circuit;
an output port being recessed into said housing, said output port being electrically coupled to said control circuit, said output port insertably receiving said power plug on said free end of said power cord such that said control circuit is in electrical communication with said heating coil;
a power button being movably integrated into said housing, said power button being electrically coupled to said control circuit for turning said control circuit on and off;
a temperature increase button being movably integrated into said housing, said temperature increase button being electrically coupled to said control circuit, a temperature of said heating coil being increased toward a maximum temperature when said temperature increase button is depressed; and
a temperature decrease button being movably integrated into said housing, said temperature decrease button being electrically coupled to said control circuit, a temperature of said heating coil being decreased toward a minimum temperature when said temperature decrease button is depressed;
a rechargeable battery being insertable into said battery well in said control unit such that said rechargeable battery is in electrical communication with said heating coil in said blanket when said power cord is plugged into said control unit, said rechargeable battery having a charging plug extending away from said rechargeable battery, said charging plug extending into said battery well in first wall of said housing of said control unit such that said charging plug electrically engages said charging contacts in said battery well;
a charger being engageable with said rechargeable battery for charging said rechargeable battery; and
a remote control being in remote communication with said control unit thereby facilitating the user to remotely control said heating coil in said blanket when said power cord is plugged into said control unit, said remote control comprising:
a transmitter being in wireless communication with said receiver associated with said control unit;
an actuate button being movably integrated into said remote control, said actuate button being electrically coupled to said transmitter, said control circuit associated with said control unit being turned on when said actuate button is manipulated;
an increase button being movably integrated into said remote control, said increase button being electrically coupled to said transmitter, said heating coil being increased toward a maximum temperature when said increase button is depressed;
an decrease button being movably integrated into said remote control, said decrease button being electrically coupled to said transmitter, said heating coil being decreased toward a maximum temperature when said decrease button is depressed; and
a remote power supply being positioned in said remote control, said remote power supply being electrically coupled to said transmitter, said remote power supply comprising at least one battery.
